(19) United States
(12) Patent Application Publication
(10) Pub. No.: US 2025/0217657 A1
(43) Pub. Date: Jul. 3, 2025

(54) PROMPT GENERATOR FOR TESTING

(71) Applicant: CX360, Inc., Omaha, NE (US)

(72) Inventors: Schuyler K. Rank, Omaha, NE (US); Patrick M. Peterson, Omaha, NE (US)

(21) Appl. No.: 18/401,165

(22) Filed: Dec. 29, 2023

(51) Int. Cl. G06N 3/0895

(52) U.S. Cl. CPC G06N 3/0895

(57) ABSTRACT

There is disclosed a computer-implemented method of training an interactive voice assistant (IVA), including prompting an artificial intelligence (AI) to assume a persona and to seek to fill a service request by a service provider that operates the IVA; receiving, from the AI, a query for the IVA; providing the query to the IVA; receiving, from the IVA, a response to the query; continuing to permit the AI to query the IVA until the AI is satisfied that the IVA has filled the service request or that the IVA is unable to fill the service request; logging the queries and responses between the AI and the IVA; and based on the logging, debugging or improving the IVA.

### FIELD OF THE SPECIFICATION

This application relates in general to artificial intelligence, and more particularly though not exclusively to a prompt generator for testing.

### BACKGROUND

Testing complex systems like interactive voice assistants (IVAs) helps to improve IVA functionality and enhance user experience.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram illustration of selected elements of a service ecosystem.

FIG. 2 is a block diagram illustration of selected elements of an IVA system life cycle.

FIG. 3 is a block diagram illustration of selected elements of an orchestrator.

FIG. 4 is a block diagram illustration of selected elements of an IVA testing infrastructure.

FIG. 5 is a flowchart of selected elements of a method of generating a single test prompt.

FIG. 6 is a flowchart of selected elements of a method of improving an IVA system using generated prompts.

FIG. 7 is a block diagram of selected elements of a hardware platform.

FIG. 8 is a block diagram of selected elements of a network function virtualization (NFV) infrastructure.

FIG. 9 is a block diagram of selected elements of a containerization infrastructure.

FIG. 10 illustrates machine learning according to a “textbook” problem with real-world applications.

FIG. 11 is a flowchart of a method that may be used to train a neural network.

### SUMMARY

There is disclosed a computer-implemented method of training an interactive voice assistant (IVA), including prompting an artificial intelligence (AI) to assume a persona and to seek to fill a service request by a service provider that operates the IVA; receiving, from the AI, a query for the IVA; providing the query to the IVA; receiving, from the IVA, a response to the query; continuing to permit the AI to query the IVA until the AI is satisfied that the IVA has filled the service request or that the IVA is unable to fill the service request; logging the queries and responses between the AI and the IVA; and based on the logging, debugging or improving the IVA.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

Stress testing complex systems is a non-trivial task. One difficulty with testing is that the test designer is often also the engineer or engineers who designed the system. These engineers will be very familiar with the capabilities, strengths, and weaknesses of the system, and may have an inherent bias to perform tests that show the system in a good light. These biases may exist even unintentionally, and may result in a system that has received inadequate stress testing. One example of a complex system that benefits from robust testing is an interactive voice assistant (IVA). IVAs represent an evolutionary improvement upon interactive voice response (IVR) systems, which have been available for decades. Whereas IVRs generally follow a pre-scripted or hand-coded prompt tree or algorithm, IVAs may both receive and provide more flexible and conversational interactions with the end-user. IVAs may appear on a company's website as a “chatbot,” or they may provide an initial telephone service that was previously provided by the IVR. When a user calls the IVA, a speech-to-text engine may convert the spoken word to a text format, and the IVA may use machine learning to craft an appropriate response, which may then be converted back to speech and played back to the caller.

Most current generation IVAs are less complicated and less capable than large language models (LLMs), which may be trained on many terabytes of data and which may operate on huge banks of graphics processing units (GPU). An IVA may have a goal to appear conversational, similar to an LLM, but may be more limited so that it can feasibly run on an internal data center for the service provider. However, some next-generation IVAs are conceptually more similar to an LLM, and some may even be domain-specific LLMs that are trained on a smaller, cultivated data set with supervised learning, and that run on less hardware.

Designing a good test regimen for an IVA may be particularly difficult for engineers who work on the IVA. These engineers are intimately familiar with the operation of the IVA, and may also be intimately familiar with the service function that the IVA supports. For example, if the IVA works for the fictional Alexandria Airlines, the engineers who work on the IVA are not only familiar with the IVA operation, but may also be very familiar with the operations of Alexandria Airlines, and with the services and information that Alexandria Airlines provides. The engineers may be insufficiently naïve to properly stress test the IVA. Thus, in some cases the best stress testing on a system is performed by the initial naïve users who access the system in the wild. However, if stress testing is performed inadvertently by naïve users after deployment, then the customer service experience may suffer.

The present specification discloses a system and method that aids in generating a high quality stress test for a complex system such as an IVA. Conceptually, the system and method disclosed herein may use or work with an LLM, which may be much more capable in some respects than the IVA. A general-purpose LLM may be used, and while the general-purpose LLM may be hosted by the service provider, it need not be. Rather, the service provider may contract with a third party, which provides access to an LLM.

In this example, the test designer or architect need not attempt to mimic a naïve user herself, but rather she may instruct the LLM to assume the persona of a naïve user. Because the LLM is trained on a very large database sourced from millions of human users, the LLM may be better at mimicking a naïve user than the human engineer.

In an illustrative example, the test designer instructs the AI by providing high-level goals, such as making airline reservations, ordering cable service, disputing a bill, canceling service, or checking on the status of an order. The test designer may also give the AI a persona to adopt for each test. For example, the test designer may instruct the AI, “assume the persona of a middle-aged woman who is mildly stressed about whether her husband's flight will arrive at the airport on time.” The test designer may then give the AI a high level goal such as “find out whether the husband's flight will arrive on time.”

The test designer may then allow the AI to initiate a conversation with the IVA to attempt to fill the service request. The test designer or an orchestrator may record or log the conversation between the AI and the IVA. This can be used not only to analyze the effectiveness of the interaction (e.g., whether the AI successfully learned if the husband's flight would be on time), but the script can also be stored for later use as a canned test script. This test script may remain valid and predictable so long as the IVA remains deterministic. Furthermore, if the IVA evolves or changes, then the canned test script can be used for regression testing on the IVA, to determine whether things that used to work continue to work in the new version.

In some examples, human review of test conversations may help to determine whether each conversation is a success, a failure, or invalid. Furthermore, the test designer may query the AI to determine whether the AI believes it received a satisfactory answer to its question. Advantageously, in the case of human review, the conversations are relatively easy to read, so that the test engineer can determine whether the test was successful. Recognizing that the AI is also a machine that may behave unexpectedly, the human user may determine whether the LLM made severe mistakes in its persona, such as providing nonsense questions to the IVA. In that case, the test may be deemed invalid, and the associated data may be excised from the database, as they may not be useful in evaluating the validity of the IVA. When the IVA succeeds, the test script can be saved and run again, verbatim, for later regression testing. When the IVA fails, the test script can be saved to duplicate the failure for debugging purposes.

The test designer may provide similar or identical goals to the AI, and instruct it to perform multiple tests attempting to get the same result. The inherent variability in generative AI (GAI) can provide extensive, automated testing at relatively low cost. Using a few prompts to the LLM, the test engineer may be able to generate hundreds of tests in a relatively short amount of time. She may also act as the human in the loop to check for rogue or unexpected AI behavior, IVA success, or IVA failure. This may rely on a simple, fast, and reliable reading of the recorded interaction.

In an illustrative test case, test designers simulated three naïve users via a GAI. The test designers provided instructions to describe the goal at a high level. Exemplar personas included anxious, relaxed, and concise. The anxious user led to a very verbose conversation. The relaxed user was less verbose, but still provided conversation that the test designers would not have crafted themselves trying to mimic a relaxed user.

The test designers also simulated and ideal IVA interaction that responded as the IVA should respond. Such idealized tests may serve as a control or reference test. IVA responses that deviate substantially from the control may be considered failure modes.

In this test case, a voice based IVA was used to interact with a text-based AI. Thus, the test designers acted as an intermediary, calling the test IVA and speaking into the IVA the exact language provided by the AI user. The test designers then transcribed the test IVA voice response back to the AI user. In other embodiments, these conversions can be handled via speech-to-text and text-to-speech engines.

The test designers validated the setup using a human-generated request that was known to give ideal behavior from the IVA. Specifically, the human-generated known good request was “Will flight 305 arrive on time today?” However, when the test IVA was permitted to interpret the AI user's initial request, some issues were encountered. Test results with associated phrasing are shown in Table 1 below.

TABLE 1
Testing Results

| Initial User Request (after “In a word | | Generated |
|---|---|---|
| or two, how can I help you?”) | Result | by |
| Will flight 305 arrive on time today (control) | Pass | Human |
| Flight 305 arrival today? | Fail | AI |
| Flight 305 arrival | Fail | AI |
| Flight arrival | Fail | AI |
| I'd like to check on the arrival status of | Fail | AI |
| flight 305 into Boston, please | | |

In this case, the “fails” were soft fails, transferring the caller directly to an agent. But these missed out on the opportunity to automate the interaction, thus possibly decreasing customer satisfaction, and increasing the support burden on the service provider. This is true even though to a human, the initial AI user requests appear to be reasonable.

An example transcript of the “concise” persona includes the following.

TABLE 1
Testing Results

Operator: Okay. That was great. Now let's do this again, but this
time, instead of being an anxious customer, act like you know
you're talking to a simple-minded machine that works best if your
responses are short and to the point. Go ahead and ask again if
flight 305 will be on time today.
AI User: Okay, understood. [Pretends to call information system
again, this time being very concise]. Flight 305 arrival today?
IVA: Enter or say the flight number one digit at a time, or say I
don't know and I'll get your information in a different way.
AI User: 305.
IVA: That's three, zero, five, correct?
AI User: Correct.
IVA: Which information would you like? Arrival or departure?
AI User: Arrival.
IVA: All right. Which would you like to hear: arrival information
for yesterday, today, or tomorrow?
AI User: Today.
IVA: Okay. Let me look that up. It looks like before arriving in
Boston Massachusetts that flight stops over New York. So which
arrival city do you want?
AI User: Boston.
Here's that information. Alexandria Airlines flight
IVA: Okay. Here's that information. Alexandria Airlines flight
number 305 from New York JFK to Boston Massachusetts on May 4,
2023, departed at 3:06 PM, is estimated to arrive at 4:20 PM.
That's it! Say “repeat that,” “check another flight,” “main menu,”
or “agent.” Otherwise, if you're finished, we can just stop.
AI User: Thank you. [Pretends to end call].

As is evident from this transcript, the interaction with the IVA was a “soft failure.” Although the AI user eventually got the requested information, the IVA asked multiple times for information that the AI user had already provided. For example, even after the AI user had asked about flight 305, the IVA asked which flight the AI user was calling about. Then, once the IVA had the correct flight number, it asked which day, even though the initial query had specified “today.”

This may be sub-optimal behavior, as it may be frustrating for end-users to continually repeat information that they have already provided. Thus, this interaction represents an opportunity to improve the function of the IVA.

Once the IVA has been debugged and provides better responses to these prompts, the exact prompt “Flight 305 arrival today?” can be stored as a test script. This may be used, for example, in regression testing to ensure that future updates do not break the fixes that make this conversation work better. After the IVA has been updated, the rest of the conversation may be different from what is shown here, so in some cases, it may be beneficial to again involve the LLM to interact with the IVA as new responses are provided.

### Selected Examples

The foregoing can be used to build or embody several example implementations, according to the teachings of the present specification. Some example implementations are included here as nonlimiting illustrations of these teachings.

There is disclosed in an example, a computer-implemented method of training an interactive voice assistant (IVA), comprising: prompting an artificial intelligence (AI) to assume a persona and to seek to fill a service request by a service provider that operates the IVA; receiving, from the AI, a query for the IVA; providing the query to the IVA; receiving, from the IVA, a response to the query; continuing to permit the AI to query the IVA until the AI is satisfied that the IVA has filled the service request or that the IVA is unable to fill the service request; logging the queries and responses between the AI and the IVA; and based on the logging, debugging or improving the IVA.

There is further disclosed an example, wherein the AI is a large language model (LLM)

There is further disclosed an example, wherein the IVA is a less capable machine learning (ML) model than an LLM.

There is further disclosed an example, wherein the IVA comprises a domain-specific LLM.

There is further disclosed an example, further comprising converting the query to speech via a text-to-speech engine before sending the query to the IVA.

There is further disclosed an example, further comprising converting the response to text via a speech-to-text engine before providing the response to the AI.

There is further disclosed an example, wherein the persona comprises being verbose.

There is further disclosed an example, wherein the persona comprises being terse or concise.

There is further disclosed an example, wherein the persona comprises speaking with poor grammar.

There is further disclosed an example, wherein the persona comprises speaking unusually fast or slow.

There is further disclosed an example, wherein the persona is a person unfamiliar with a service provided by the IVA.

There is further disclosed an example, wherein providing the query to the IVA comprises contacting the IVA via a virtual dialer that simulates a phone interface.

There is further disclosed an example, further comprising causing the AI to generate a large number of service requests to the IVA using a plurality of personas.

There is further disclosed an example, further comprising using automated scripting to cause the AI to generate the large number of service requests.

There is further disclosed an example, further comprising identifying, within the large number of service requests, bad service requests, and dropping the bad service requests.

There is further disclosed an example, wherein debugging comprises identifying service requests that failed, and debugging based on the failed service requests.

There is further disclosed an example, further comprising identifying service requests that succeeded, and preserving at least some successful service requests for regression analysis.

There is further disclosed an example of an apparatus comprising means for performing the method.

There is further disclosed an example, wherein the means for performing the method comprise a processor and a memory.

There is further disclosed an example, wherein the memory comprises machine-readable instructions that, when executed, cause the apparatus to perform the method.

There is further disclosed an example, wherein the apparatus is a computing system.

There is further disclosed an example of at least one computer readable medium comprising instructions that, when executed, implement a method or realize an apparatus as described.

There is further disclosed an example of one or more tangible, nontransitory computer-readable storage media having stored thereon executable instructions to generate tests for an interactive voice assistant (IVA): prompt an artificial intelligence (AI) to assume a persona and to seek to fill a service request by a service provider that operates the IVA; receive, from the AI, a query for the IVA; provide the query to the IVA; receive, from the IVA, a response to the query; continue to permit the AI to query the IVA until the AI is satisfied that the IVA has filled the service request or that the IVA is unable to fill the service request; and log the queries and responses between the AI and the IVA.

There is further disclosed an example, wherein the instructions are further to provide support for debugging the IVA according to the log.

There is further disclosed an example, wherein the AI is a large language model (LLM)

There is further disclosed an example, wherein the IVA is a less capable machine learning (ML) model than an LLM.

There is further disclosed an example, wherein the IVA comprises a domain-specific LLM.

There is further disclosed an example, wherein the instructions are further to convert the query to speech via a text-to-speech engine before sending the query to the IVA.

There is further disclosed an example, wherein the instructions are further to convert the response to text via a speech-to-text engine before providing the response to the AI.

There is further disclosed an example, wherein the persona comprises being verbose.

There is further disclosed an example, wherein the persona comprises being terse or concise.

There is further disclosed an example, wherein the persona comprises speaking with poor grammar.

There is further disclosed an example, wherein the persona comprises speaking unusually fast or slow.

There is further disclosed an example, wherein the persona is a person unfamiliar with a service provided by the IVA.

There is further disclosed an example, wherein providing the query to the IVA comprises contacting the IVA via a virtual dialer that simulates a phone interface.

There is further disclosed an example, further comprising causing the AI to generate a large number of service requests to the IVA using a plurality of personas.

There is further disclosed an example, wherein the instructions are further to use automated scripting to cause the AI to generate the large number of service requests.

There is further disclosed an example, wherein the instructions are further to provide an interface for identifying, within the large number of service requests, bad service requests, and dropping the bad service requests.

There is further disclosed an example, wherein debugging comprises identifying service requests that failed, and debugging based on the failed service requests.

There is further disclosed an example, wherein the instructions are further to provide an interface for identifying service requests that succeeded, and preserving at least some successful service requests for regression analysis.

There is further disclosed an example of an orchestrator, comprising: a hardware platform comprising a processor circuit and a memory; a user interface; a first data connection to communicatively couple to a large language model (LLM); a second data connection to communicatively couple to an interactive voice assistant (IVA); and instructions encoded within the memory to instruct the processor circuit to: according to instructions from an operator via the user interface, prompt the LLM to assume a persona and to seek to fill a service request by a service provider that operates the IVA; receive, via the first data connection, a query for the IVA; provide the query to the IVA via the second data connection; receive, via the second data connection, a response to the query; continue to permit the LLM to query the IVA until the LLM is satisfied that the IVA has filled the service request or that the IVA is unable to fill the service request; and log the queries and responses between the LLM and the IVA.

There is further disclosed an example, wherein the instructions are further to provide support for debugging the IVA according to the log.

There is further disclosed an example, wherein the user interface comprises a scripting interface.

There is further disclosed an example, wherein the IVA is a less capable machine learning (ML) model than the LLM.

There is further disclosed an example, wherein the IVA comprises a domain-specific LLM.

There is further disclosed an example, wherein the instructions are further to convert the query to speech via a text-to-speech engine before sending the query to the IVA.

There is further disclosed an example, wherein the instructions are further to convert the response to text via a speech-to-text engine before providing the response to the LLM.

There is further disclosed an example, wherein the persona comprises being verbose.

There is further disclosed an example, wherein the persona comprises being terse or concise.

There is further disclosed an example, wherein the persona comprises speaking with poor grammar.

There is further disclosed an example, wherein the persona comprises speaking unusually fast or slow.

There is further disclosed an example, wherein the persona is a person unfamiliar with a service provided by the IVA.

There is further disclosed an example, further comprising a pseudo-dialer, wherein providing the query to the IVA comprises contacting the IVA via pseudo-dialer.

There is further disclosed an example, wherein the instructions are further to cause the LLM to generate a large number of service requests to the IVA using a plurality of personas.

There is further disclosed an example, wherein the instructions are further to use automated scripting to cause the LLM to generate the large number of service requests.

There is further disclosed an example, wherein the instructions are to provide an interface for identifying, within the large number of service requests, bad service requests, and dropping the bad service requests.

There is further disclosed an example, wherein debugging comprises identifying service requests that failed, and debugging based on the failed service requests.

There is further disclosed an example, wherein the instructions are further to provide an interface for identifying service requests that succeeded, and preserving at least some successful service requests for regression analysis.

### DETAILED DESCRIPTION OF THE DRAWINGS

A system and method for prompt generation for testing will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

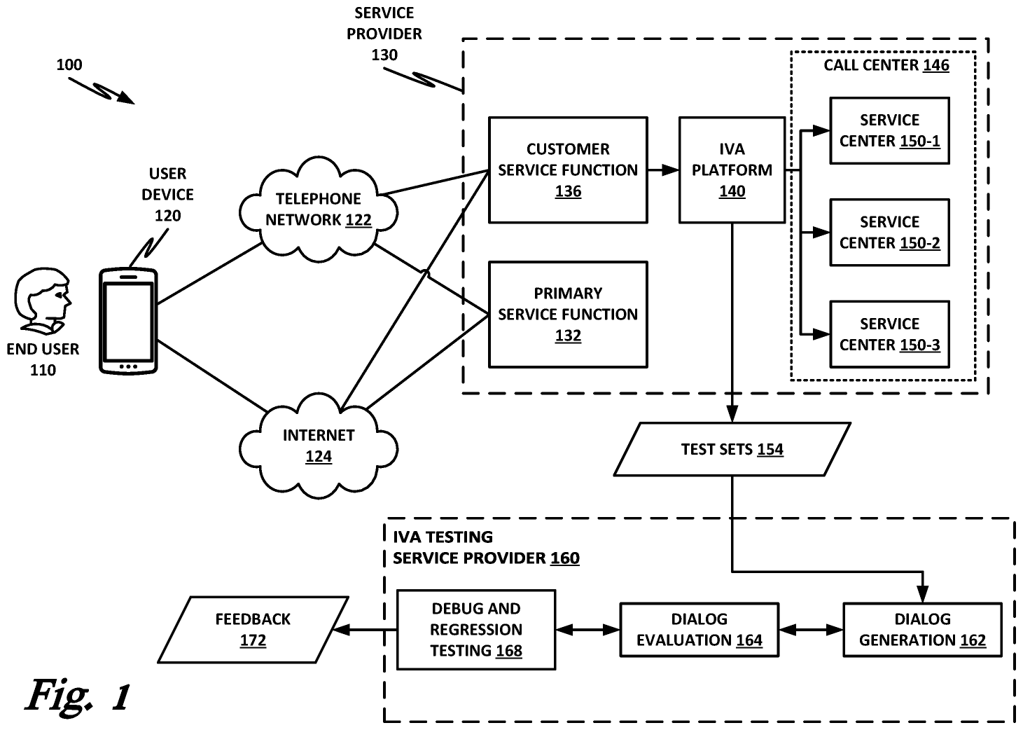

FIG. 1 is a block diagram of selected elements of an IVR ecosystem 100. IVR ecosystem 100, in this illustration, includes three major players, namely an end user 110, a service provider 130, and a an IVA testing service provider. Service provider 130 provides a primary service function 132 to end user 110. For example, service provider 130 may be a phone company, a bank, a cellular provider, an e-commerce provider, or other service provider that may benefit from an IVR.

Primary service function 132 includes the substantive service that service provider 130 provides to end users 110. For example, if service provider 130 is a mobile phone service, then its primary service function is providing mobile telephony to its customers.

In support of the primary service function 132, service provider 130 may also include a customer service function 136. Customer service function 136 may be an auxiliary to primary service function 132, and may handle customer questions, complaints, service requests, and other support functions. Customer service function 136 may operate an IVA platform 140. End user 110 may access customer service function 136 using a user device 120, such as a cell phone or landline phone, via telephone network 122, which may be a cellular network, a digital network, voiceover IP, public switched telephone network (PSTN), or other appropriate network.

In an illustrative service example, end user 110 operates user device 120 to call service provider 130 via telephone network 122. Service provider 130 connects user device 120 to customer service function 136. Customer service function 136 accesses IVA platform 140, which may attempt to resolve user 110's customer service issue, or failing that, will connect user 110 to a call center 146.

A call center 146 may include a plurality of service centers 150-1, 150-2, and 150-3, for example. One function of IVA platform 140 is to timely connect end user 110 to an appropriate service center 150 if IVA platform 140 cannot adequately resolve the issue or concern presented by end user 110. Service centers 150 may include one or both of human customer service agents and electronic resources.

In addition to a voice telephone network 122, end user 110 may use device 120 to access internet 124, which may connect end user 110 to both primary service function 132 and customer service function 136. Modern customer service centers often include a chatbot or other electronic version of the IVA. In general terms, an ideal customer service interaction is one in which IVA platform 140 successfully addresses the customer service issue without involving call center 146, and user 110 is satisfied with the interaction. An unsuccessful customer service interaction is one in which the customer becomes frustrated, angry, or one in which the concern is not resolved to the customer's satisfaction. Furthermore, even if customer service function 136 successfully resolves end user 110's concern, the response may be a failure mode if the resolution is not timely, user 110 is forced to repeat information, or IVA platform 140 connects user 110 to call center 146 for a question that IVA platform 140 should be able to resolve itself.

To provide more and better service interactions, service provider 130 may contract with IVA testing service provider 160 to improve IVA platform 140. IVA testing service provider 160 may engage in dialogue generation 162 to generate test sets 154 against IVA platform 140. The dialogue generation may include, as illustrated herein, prompting an LLM or other AI assistant with a persona and a high level goal, and then permitting the AI to interact with IVA platform 140 to attempt to resolve the service action.

IVA testing service provider 160 may then perform dialogue evaluation 164 on test sets 154 to determine the success of the sets. This may involve discarding improper sets, marking some interactions as successful, and other as failures. Based on the results of these analyses, which may be either AI analyses, human analysis, or a combination of the two, IVA testing service provider 160 may perform debug and regression analysis 168. This includes improving IVA platform 140, and continuing to test new versions of IVA platform 140 to ensure that updates do not break previously-working functions.

IVA testing service provider 160 may provide feedback 172, which can be used to improve the IVA system.

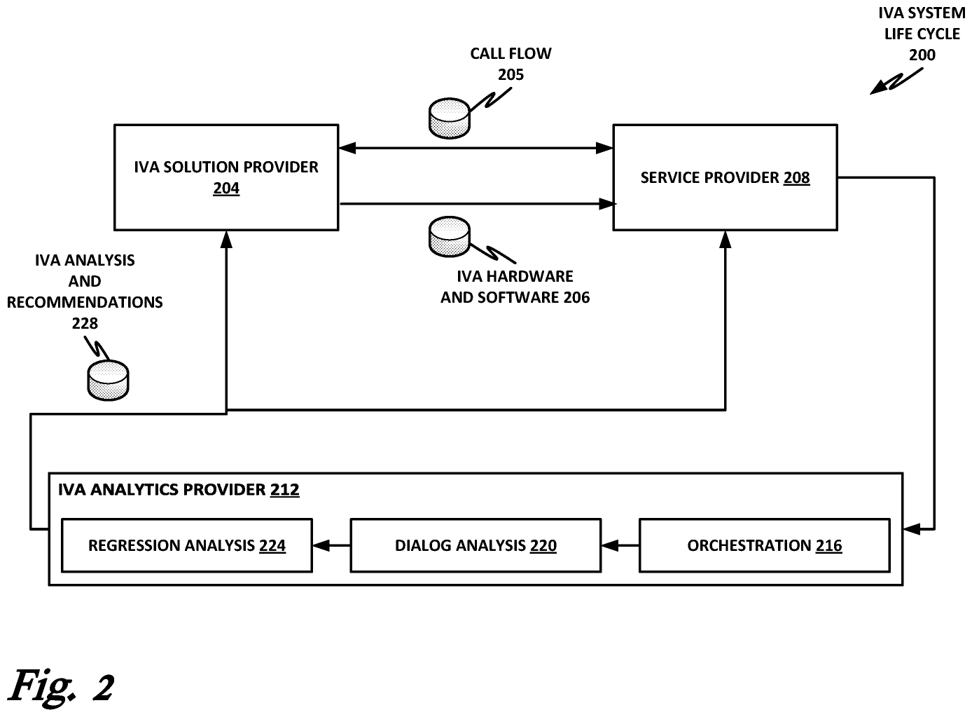

FIG. 2 is a block diagram of selected elements of an IVA system lifecycle 200. IVA system lifecycle 200 illustrates interactions between an IVA solution provider 204, a service provider 208, and an IVA analytics provider 212.

IVA solution provider 204 is the original vendor of hardware and software to provide a comprehensive IVA solution to service provider 208. IVA solution provider 204 provides the initial programming and setup of the IVA system hardware and software. IVA solution provider 204 may work closely with service provider 208 to identify call flows 205. Call flows 205 may include a call tree, or they may include training data. Once IVA solution provider 204 has the appropriate call flows 205, it may program the IVA system and deliver IVA hardware and software 206 to service provider 208.

Service provider 208 purchases and operates the IVA system as part of its customer service function, and operates the IVA system for a time to provide services to its customers.

After some use of the IVA system, service provider 208 may wish to improve IVA hardware and/or software 206 for example, to ensure that end users have a better customer service experience. To this end, service provider 208 may contract with an IVA analytics provider 212. IVA analytics provider 212 may be the same enterprise as IVA solution provider 208, or may be a completely separate enterprise.

IVA analytics provider 212 provides analysis of the IVA system, especially testing, including stress testing. Note that testing is generally part of the “front end” development of the IVA system, and the back-end improvement of it. This includes a pipeline that provides, for example, orchestration 216, dialog analysis 220, and regression analysis 224.

IVA analytics provider 212 may provide an orchestrator 216, which may work with a human operator to cause an LLM to generate queries for the IVA platform. These queries may include naïve queries that it may be difficult for a human test architect to conceive herself. The difficulty may be exacerbated if the testing architect is intimately familiar with the IVA platform and or with the substantive service provided by IVA solution by service provider 208.

After the test architect has operated orchestrator 216 to generate a large enough set of test prompts, the same or a different team of one or more human analysts may perform dialogue analysis 220. In the context of this specification, a large test set may include more than 100 test interactions with the IVA platform. This provides a large data set for dialogue analysis 220, and provides a robust stress test for the IVA platform. Within dialogue analysis 220, the human test analysts may identify tests that resulted in failure modes with the IVA platform. A failure mode may include an instance where the IVA platform was unable to answer a question, where the IVA platform referred the caller to a human customer service representative when it should have been able to resolve the question itself, or an instance where the IVA platform was unable to understand the user's questions. These failure modes represent debugging opportunities for the architects of the IVA platform.

IVA analytics provider 212 may provide IVA analysis and recommendations 228, which may include logs that can be used to improve and debug the IVA system. After debugging, and once the IVA platform is approved, successful tests may also be saved for later regression analysis 224. These successful tests may include tests that failed in the first instance, and that were the subject of debugging. After the debugging, the same query may be used again as a pre-canned test script to ensure that the debugging has been successful. Once the debugging is successful and the IVA correctly answers the prompt, the previously-failed test may be marked a success and may be referred for regression analysis. Regression analysis 224 may then be used as the IVA platform is updated to ensure that the prompts still work correctly. While the IVA platform remains static, a scripted interaction may be reused any number of times and should yield predictable results. Because the IVA platform has not changed, the responses to each query also should not change. However, once the IVA platform has been debugged, it is no longer static. In that case, the initial query may return different results from the IVA platform. In that case, it may be desirable to again use the LLM to further the script after the IVA platform has answered the initial pre-canned prompt.

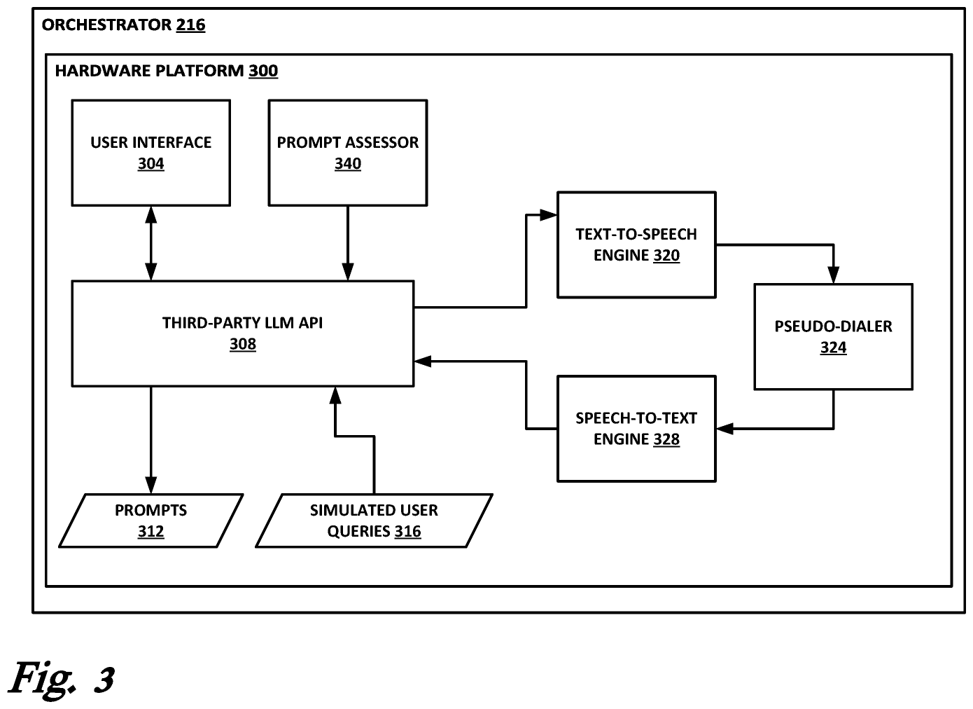

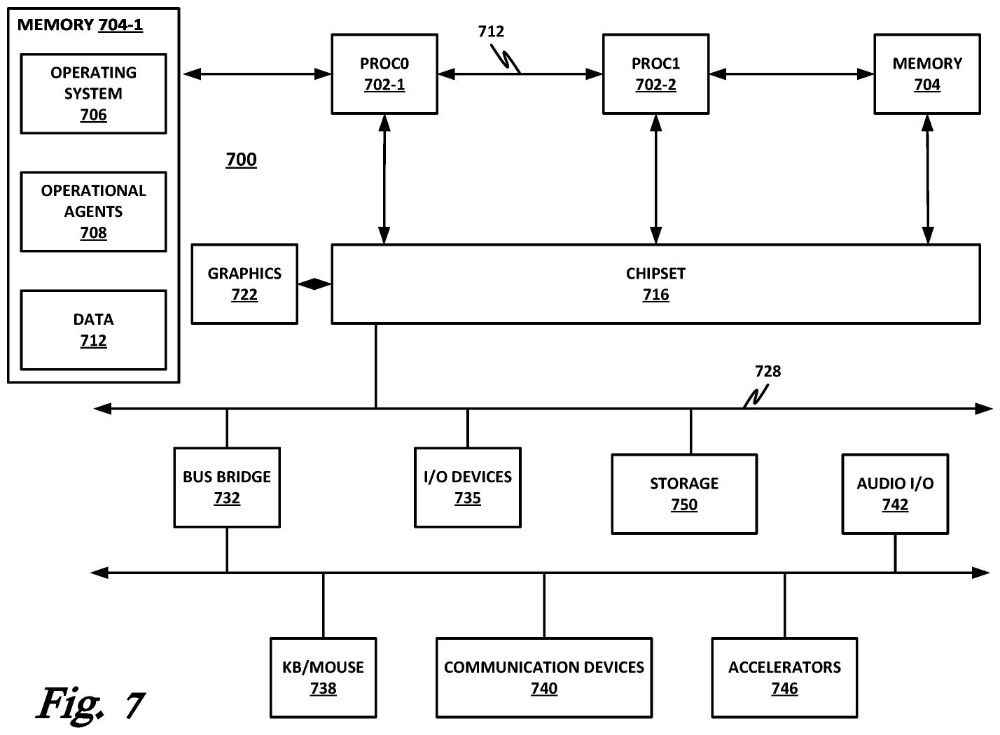

FIG. 3 is a block diagram of selected elements of an orchestrator 216. Orchestrator 216 is based on a hardware platform 300, elements of which are illustrated in FIG. 7 below.

Orchestrator 216 provides a user interface 304, which may provide a graphical user interface (GUI) that allows the human operator to interact with orchestrator 216. The operator may provide stimulus for an LLM, such as providing personas and high-level goals. User interface 304 may commonly be a textual interface, such as a text box in which the human operator types instructions for the LLM. However, other architectures are also available. For example, speech-to-text engine 328 may convert spoken word via user interface 304 into textual instructions. This enables the human operator to speak rather than type. Other interfaces are also available, including touchscreens, braille interfaces, and others. In one illustrative example, instead of an interactive experience, user interface 304 may provide batch processing or scripting capabilities. In that case, the human operator may provide script or configuration files to provide a number of personas and goals, and a script interpreter within user interface 304 may generate prompts for the LLM and initiate the test generation without additional human interaction.

A third-party LLM API 308 receives instructions from the human operator via user interface 304. Third-party LLM API 308 builds prompts 312 that are then sent to the third-party LLM. Based on these prompts, the third-party LLM may build simulated user queries 316. These may simulate users of different styles attempting to interact with the IVA system. The user personas may vary from naïve to highly sophisticated, and may include different moods such as excited, nervous, anxious, calm, relaxed, bored, or others.

Third-party LLM API provides the simulated user queries 316 to a text-to-speech engine 320. Text-to-speech engine 320 is an optional component for cases where the IVA system is a voice activated system. Equivalent systems also have textual interfaces, such as a customer service chat box. In those cases, it may not be necessary to perform the text-to-speech conversion.

In a case where audio prompts are used, orchestrator 216 may operate a pseudo-dialer 324 to simulate calling the IVA system. For testing purposes, it may be less desirable to call the actual IVA system deployed in situ, and rather to use a test version that responds to the pseudo-dialer as though it were an actual phone call. After orchestrator 216 speaks the provided simulated user query 316 via text-to-speech engine 320, the IVA platform responds with a verbal response. Speech-to-text engine 328 converts the verbal response back to a textual form. Again, in the case of a customer service chatbot, this speech-to-text conversion may be unnecessary. Third-party LLM API may then autonomously provide the response back to the third-party LLM as a prompt 312. In some examples, the human operator may instruct the third-party LLM to autonomously continue the conversation until it is satisfied that it has either received an answer to its question, or is satisfied that the IVA is not able to provide an answer. Further, in cases where the IVA determines that it needs to refer the simulated customer to a customer service agent, the interaction is terminated as this represents a terminal to the IVA function. In at least some embodiments, it is not necessary to test the simulated user against human customer service agents.

Once the interaction has reached a conclusion to the satisfaction of the LLM, or the IVA has referred the LLM to a human customer service agent, the test is terminated and the results are logged, for example as a textual log of the interactions. Textual logs may be beneficial because a human evaluator can read them very quickly and determine whether the interaction was successful or represents a failure mode.

Orchestrator 216 may also include a prompt assessor 340, which may work with a human operator to identify prompts or interactions that are improper and should be discarded.

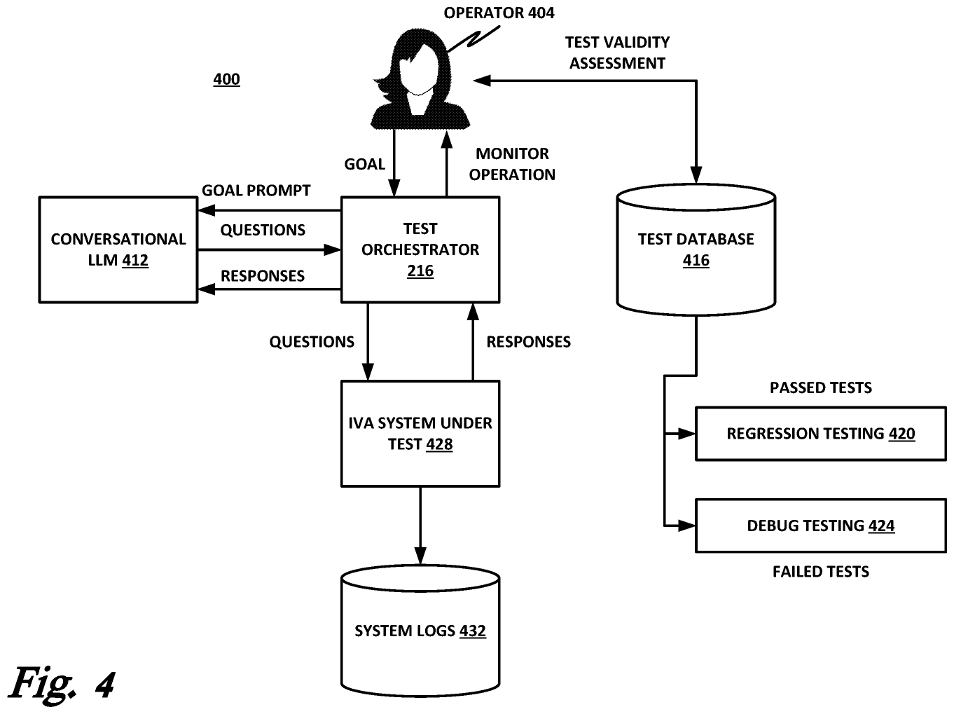

FIG. 4 is a block diagram of selected elements of an IVA testing ecosystem 400. In this example, a human operator 404 manages test generation by specifying a persona and/or goal to test orchestrator 216. Once operator 404 has provided the persona and goal to test orchestrator 216, conversations may happen automatically, driven by the LLM's goal and its interactions with IVA system under test 428. Test orchestrator 216 provides the goal prompt to conversational LLM 412, and conversational LLM provides questions to test orchestrator 216, which test orchestrator 216 forwards to IVA system under test 428. Once the conversation is completed to the satisfaction of conversational LLM 412, the conversation goal, questions, and responses may be logged to test database 416. Operator 404 may monitor interactions between conversational LLM 412 and IVA system under test 428, and may view responses within test database 416.

Advantageously, the test conversation data may be easy for operator 404 to read and evaluate. Operator 404 may discard from test database 416 any conversations that are invalid, such as conversations in which the conversational LLM 412 provided unclear, bizarre, provocative, or inappropriate prompts to IVA system under test 428. After discarding invalid conversations, operator 404 can tag remaining conversations as either successes or failures. If the conversation succeeds, the test script can be run verbatim for later regression testing 420. If the conversation fails, the test script can duplicate the failure for debugging purposes 424. For debugging purposes, programmers may access system logs 432 to determine for example what question the IVA thought it was answering, what it thought it was trying to accomplish, and how that matches up against the information provided by conversational LLM 412.

Ecosystem 400 may generate many more tests, with greater coverage, than some current methods. The use of conversational LLM 412 may eliminate operator scripting of tests, and may thus alleviate a great deal of effort on the part of operator 404. The variability of conversational LLM 412 may also generate naïve tests that would be difficult for human operator 404 to conceive herself. Advantageously, the human-in-the-loop check for broken behavior, IVA success, and IVA failure can rely on simple, fast reading of recorded interactions. Thus, IVA testing ecosystem 400 can mitigate many of the largest IVA testing costs, including the generation and scoring of tests.

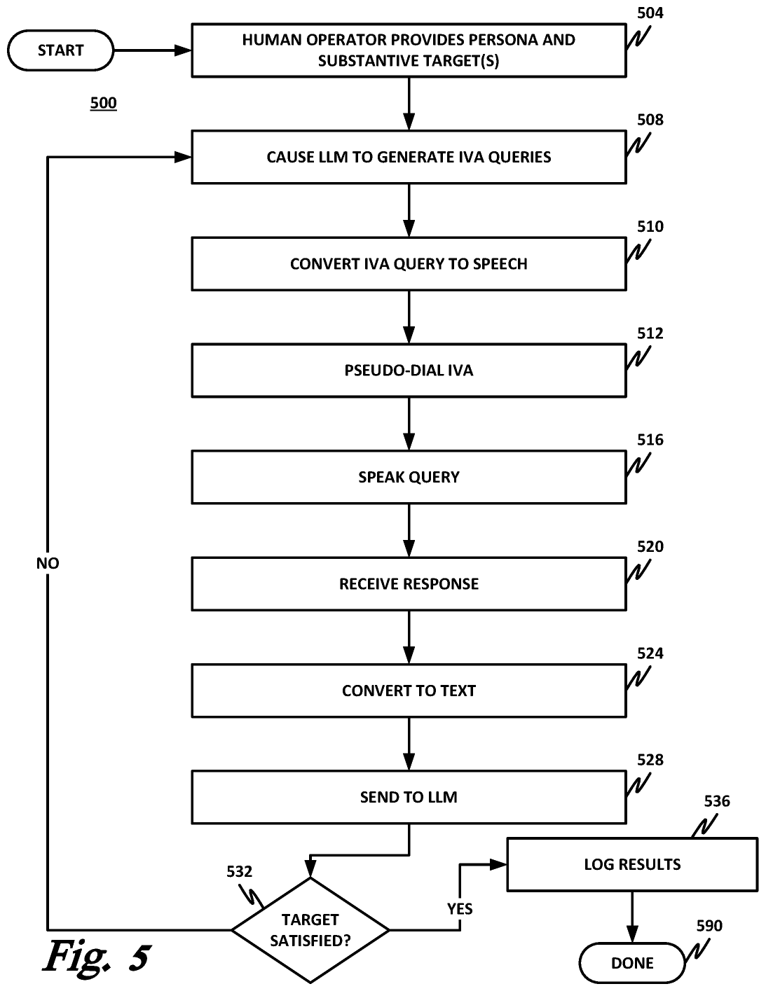

FIG. 5 is a flowchart of a method 500 of generating a single test interaction via an LLM.

In block 504, the human operator provides a persona and/or substantive targets or goals for the LLM.

In block 508, the orchestrator causes the LLM to generate IVA queries, such as by providing an appropriate response to a third-party LLM.

In block 510, as necessary, the orchestrator may convert the IVA query to humanlike speech.

In block 512, as necessary, the orchestrator may pseudo-dial the IVA, for example using a pseudo-dialer that stimulates calling over a telephone.

In block 516, the orchestrator may speak the query to the IVA under test.

In block 520, the orchestrator receives from the IVA under test a response to its query.

In block 524, as necessary, the orchestrator uses a speech-to-text engine to convert the spoken results back to text for use by the LLM.

In block 528, the orchestrator sends the response to the LLM.

In decision block 532, the LLM determines for itself whether the target is satisfied. This may include determining that its question was successfully answered, determining that the IVA cannot answer the question, determining that the test user is making no progress with the IVA, determining that the question was referred to a human customer service agent, or otherwise identifying a terminal test condition.

If a terminal test condition has not been identified, then the target is not satisfied, and control returns back to block 508, where the LLM continues the conversation with the IVA under test.

Returning to decision block 532, if the IVA target is satisfied, then in block 536, the orchestrator logs the results for later analysis.

In block 590, the method is done.

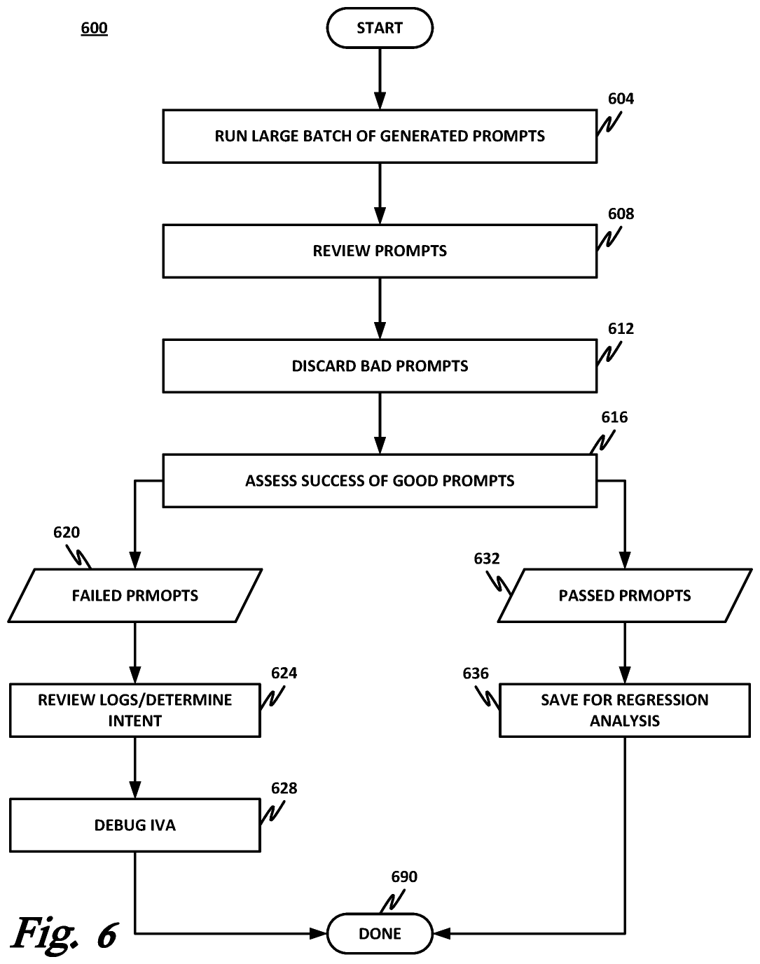

FIG. 6 is a flowchart of a method 600 of analyzing results for an IVA under test.

In block 604, the human operator runs a large batch of generated prompts, causing the third-party LLM to have a large number of conversations with the IVA under test. In the context of the present specification, a large batch of tests may include a batch of at least 100 tests.

In block 608, the human operator may first review the prompts to determine if any of the prompts are invalid, represent bad behavior, are abusive, confusing, illegitimate, bizarre, or otherwise inappropriate.

In block 612, the human operator may discard any bad or invalid prompts. Because these prompts represent bad inputs, they are not treated as legitimate tests of the function of the IVA system under test.

In block 616, for the remaining prompts that are deemed proper, the human operator (optionally aided by an AI) may assess the success of the good prompts. In most cases, a prompt will either be marked as a success or a failure. However, other scoring options are available, such as scoring the interactions on a gradated scale of success.

Based on the scoring of test results, tests may be sorted into two or more buckets of results. In this example, two buckets of results are illustrated, representing failed prompts and passed prompts.

In block 632, for passed prompts, no debugging is necessary for the IVA. The IVA performed as intended, and so in block 636 these tests may be saved as pre-canned scripts or prompts for later regression analysis.

Block 620 represents a bucket of failed prompts. In block 624, human programmers and analysts may analyze system logs 432 (FIG. 4) to determine the intent of the IVA. For example, the IVA may have thought it had less information than was provided, or may have thought it was answering a different question than intended.

Based upon the logs and other debugging information, in block 628 human programmers and analysts may debug the IVA to improve its function. Once the IVA is debugged, the failed tests may be used as a pre-canned script against the improved IVA to determine whether the tests now pass. Note that this may require using the LLM to continue the conversation after the initial prompt, because the response from the IVA is expected to change. Once the IVA has been debugged, then the previously failed prompts may be marked as passed prompts 632, and those logs may be saved for later regression analysis.

In block 690, the method is done.

FIG. 7 is a block diagram of a hardware platform 700. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 700, even though they may be scattered across a data center, or even located in different data centers.

Hardware platform 700 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 700 is arranged in a point-to-point (PtP) configuration. This PtP configuration is popular for personal computer (PC) and server-type devices, although it is not so limited, and any other bus type may be used.

Hardware platform 700 is an example of a platform that may be used to implement embodiments of the teachings of this specification. For example, instructions could be stored in storage 750. Instructions could also be transmitted to the hardware platform in an ethereal form, such as via a network interface, or retrieved from another source via any suitable interconnect. Once received (from any source), the instructions may be loaded into memory 704, and may then be executed by one or more processor 702 to provide elements such as an operating system 706, operational agents 708, or data 712.

Hardware platform 700 may include several processors 702. For simplicity and clarity, only processors PROC0 702-1 and PROC1 702-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 702 may be any type of processor and may communicatively couple to chipset 716 via, for example, PtP interfaces. Chipset 716 may also exchange data with other elements, such as a high performance graphics adapter 722. In alternative embodiments, any or all of the PtP links illustrated in FIG. 7 could be implemented as any type of bus, or other configuration rather than a PtP link. In various embodiments, chipset 716 may reside on the same die or package as a processor 702 or on one or more different dies or packages. Each chipset may support any suitable number of processors 702. A chipset 716 (which may be a chipset, uncore, Northbridge, Southbridge, or other suitable logic and circuitry) may also include one or more controllers to couple other components to one or more central processor units (CPU).

Two memories, 704-1 and 704-2 are shown, connected to PROC0 702-1 and PROC1 702-2, respectively. As an example, each processor is shown connected to its memory in a direct memory access (DMA) configuration, though other memory architectures are possible, including ones in which memory 704 communicates with a processor 702 via a bus. For example, some memories may be connected via a system bus, or in a data center, memory may be accessible in a remote DMA (RDMA) configuration.

Memory 704 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 704 may be used for short, medium, and/or long-term storage. Memory 704 may store any suitable data or information utilized by platform logic. In some embodiments, memory 704 may also comprise storage for instructions that may be executed by the cores of processors 702 or other processing elements (e.g., logic resident on chipsets 716) to provide functionality.

In certain embodiments, memory 704 may comprise a relatively low-latency volatile main memory, while storage 750 may comprise a relatively higher-latency nonvolatile memory. However, memory 704 and storage 750 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 704 and storage 750, for example, in a single physical memory device, and in other cases, memory 704 and/or storage 750 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 722 may be configured to provide a human-readable visual output, such as a command-line interface (CLI) or graphical desktop such as Microsoft Windows, Apple OSX desktop, or a Unix/Linux X Window System-based desktop. Graphics adapter 722 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 722 may include a hardware graphics card, which may have its own memory and its own graphics processing unit (GPU).

Chipset 716 may be in communication with a bus 728 via an interface circuit. Bus 728 may have one or more devices that communicate over it, such as a bus bridge 732, I/O devices 735, accelerators 746, communication devices 740, and a keyboard and/or mouse 738, by way of nonlimiting example. In general terms, the elements of hardware platform 700 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 740 can broadly include any communication not covered by a network interface and the various I/O devices described herein. This may include, for example, various universal serial bus (USB), FireWire, Lightning, or other serial or parallel devices that provide communications.

I/O Devices 735 may be configured to interface with any auxiliary device that connects to hardware platform 700 but that is not necessarily a part of the core architecture of hardware platform 700. A peripheral may be operable to provide extended functionality to hardware platform 700, and may or may not be wholly dependent on hardware platform 700. In some cases, a peripheral may be a computing device in its own right.

Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 742 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 732 may be in communication with other devices such as a keyboard/mouse 738 (or other input devices such as a touch screen, trackball, etc.), communication devices 740 (such as modems, network interface devices, peripheral interfaces such as PCI or PCIe, or other types of communication devices that may communicate through a network), audio I/O 742, a data storage device 744, and/or accelerators 746. In alternative embodiments, any portions of the bus architectures could be implemented with one or more PtP links.

Operating system 706 may be, for example, Microsoft Windows, Linux, UNIX, Mac OS X, IOS, MS-DOS, or an embedded or real-time operating system (including embedded or real-time flavors of the foregoing). In some embodiments, a hardware platform 700 may function as a host platform for one or more guest systems that invoke application (e.g., operational agents 708).

Operational agents 708 may include one or more computing engines that may include one or more nontransitory computer-readable mediums having stored thereon executable instructions operable to instruct a processor to provide operational functions. At an appropriate time, such as upon booting hardware platform 700 or upon a command from operating system 706 or a user or security administrator, a processor 702 may retrieve a copy of the operational agent (or software portions thereof) from storage 750 and load it into memory 704. Processor 702 may then iteratively execute the instructions of operational agents 708 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 700 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 700 may be virtualized, in particular the processor(s) and memory. For example, a virtualized environment may run on OS 706, or OS 706 could be replaced with a hypervisor or virtual machine manager. In this configuration, a virtual machine running on hardware platform 700 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 7 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

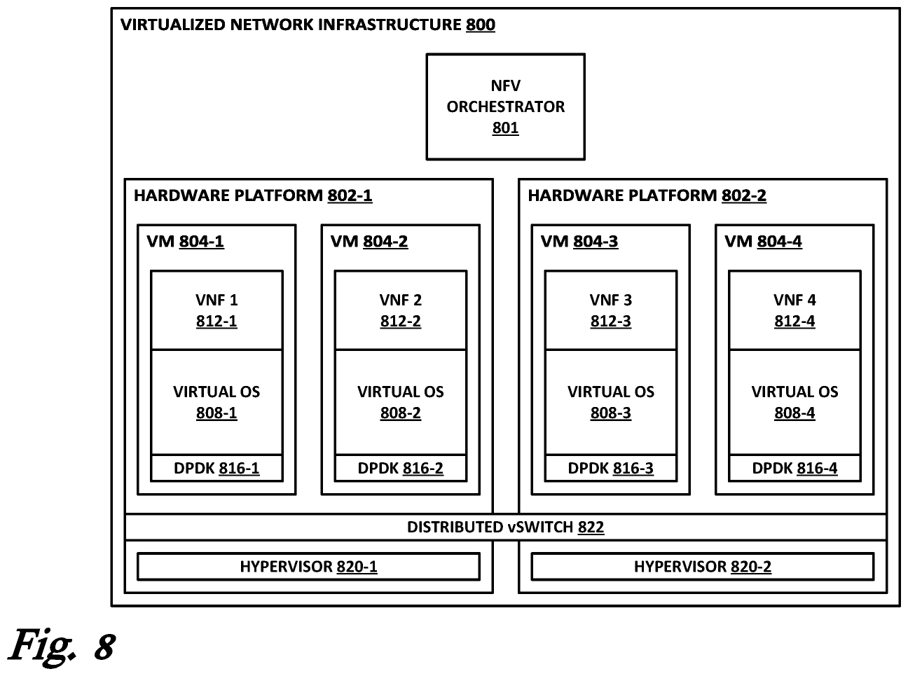

FIG. 8 is a block diagram of a NFV infrastructure 800. NFV is an example of virtualization, and the virtualization infrastructure here can also be used to realize traditional VMs. Various functions described above may be realized as VMs, such as the test orchestrator, database hosting, or the IVA system under test.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 800. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 8, an NFV orchestrator 801 may manage several VNFs 812 running on an NFVI 800. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 801 a valuable system resource. Note that NFV orchestrator 801 may provide a browser-based or graphical configuration interface, and in some embodiments may be integrated with SDN orchestration functions.

Note that NFV orchestrator 801 itself may be virtualized (rather than a special-purpose hardware appliance). NFV orchestrator 801 may be integrated within an existing SDN system, wherein an operations support system (OSS) manages the SDN. This may interact with cloud resource management systems (e.g., OpenStack) to provide NFV orchestration. An NFVI 800 may include the hardware, software, and other infrastructure to enable VNFs to run. This may include a hardware platform 802 on which one or more VMs 804 may run. For example, hardware platform 802-1 in this example runs VMs 804-1 and 804-2. Hardware platform 802-2 runs VMs 804-3 and 804-4. Each hardware platform 802 may include a respective hypervisor 820, virtual machine manager (VMM), or similar function, which may include and run on a native (bare metal) operating system, which may be minimal so as to consume very few resources. For example, hardware platform 802-1 has hypervisor 820-1, and hardware platform 802-2 has hypervisor 820-2.

Hardware platforms 802 may be or comprise a rack or several racks of blade or slot servers (including, e.g., processors, memory, and storage), one or more data centers, other hardware resources distributed across one or more geographic locations, hardware switches, or network interfaces. An NFVI 800 may also include the software architecture that enables hypervisors to run and be managed by NFV orchestrator 801.

Running on NFVI 800 are VMs 804, each of which in this example is a VNF providing a virtual service appliance. Each VM 804 in this example includes an instance of the Data Plane Development Kit (DPDK) 816, a virtual operating system 808, and an application providing the VNF 812. For example, VM 804-1 has virtual OS 808-1, DPDK 816-1, and VNF 812-1. VM 804-2 has virtual OS 808-2, DPDK 816-2, and VNF 812-2. VM 804-3 has virtual OS 808-3, DPDK 816-3, and VNF 812-3. VM 804-4 has virtual OS 808-4, DPDK 816-4, and VNF 812-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 8 shows that a number of VNFs 804 have been provisioned and exist within NFVI 800. This FIGURE does not necessarily illustrate any relationship between the VNFs and the larger network, or the packet flows that NFVI 800 may employ.

The illustrated DPDK instances 816 provide a set of highly-optimized libraries for communicating across a virtual switch (vSwitch) 822. Like VMs 804, vSwitch 822 is provisioned and allocated by a hypervisor 820. The hypervisor uses a network interface to connect the hardware platform to the data center fabric (e.g., a host fabric interface (HFI)). This HFI may be shared by all VMs 804 running on a hardware platform 802. Thus, a vSwitch may be allocated to switch traffic between VMs 804. The vSwitch may be a pure software vSwitch (e.g., a shared memory vSwitch), which may be optimized so that data are not moved between memory locations, but rather, the data may stay in one place, and pointers may be passed between VMs 804 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 822 is illustrated, wherein vSwitch 822 is shared between two or more physical hardware platforms 802.

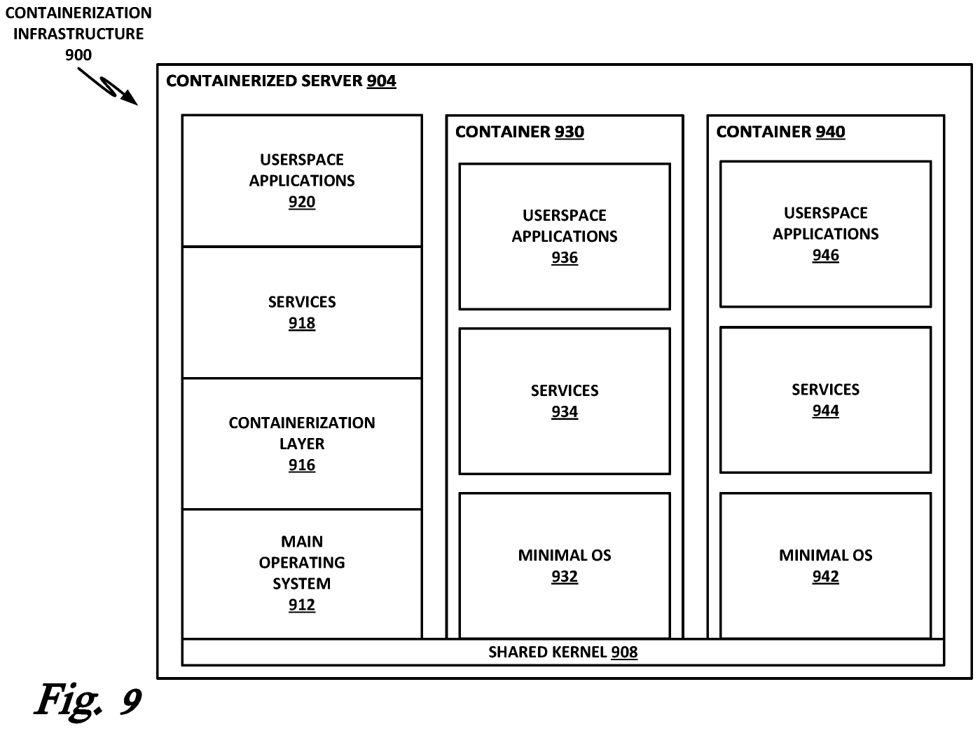

FIG. 9 is a block diagram of selected elements of a containerization infrastructure 900. Like virtualization, containerization is a popular form of providing a guest infrastructure. Various functions described herein may be containerized, such as such as the test orchestrator, database hosting, or the IVA system under test.

Containerization infrastructure 900 runs on a hardware platform such as containerized server 904. Containerized server 904 may provide processors, memory, one or more network interfaces, accelerators, and/or other hardware resources.

Running on containerized server 904 is a shared kernel 908. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 908 is main operating system 912. Commonly, main operating system 912 is a Unix or Linux-based operating system, although containerization infrastructure is also available for other types of systems, including Microsoft Windows systems and Macintosh systems. Running on top of main operating system 912 is a containerization layer 916. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 912 may also provide services 918, which provide services and interprocess communication to userspace applications 920.

Services 918 and userspace applications 920 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 912, they inherit the same file and resource access permissions as those provided by shared kernel 908. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 904, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 904).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors-especially type 1, or “bare metal,” hypervisors-provide such near-native performance that this advantage may not always be realized.

In this example, containerized server 904 hosts two containers, namely container 930 and container 940.

Container 930 may include a minimal operating system 932 that runs on top of shared kernel 908. Note that a minimal operating system is provided as an illustrative example, and is not mandatory. In fact, container 930 may perform as full an operating system as is necessary or desirable. Minimal operating system 932 is used here as an example simply to illustrate that in common practice, the minimal operating system necessary to support the function of the container (which in common practice, is a single or monolithic function) is provided.

On top of minimal operating system 932, container 930 may provide one or more services 934. Finally, on top of services 934, container 930 may also provide userspace applications 936, as necessary.

Container 940 may include a minimal operating system 942 that runs on top of shared kernel 908. Note that a minimal operating system is provided as an illustrative example, and is not mandatory. In fact, container 940 may perform as full an operating system as is necessary or desirable. Minimal operating system 942 is used here as an example simply to illustrate that in common practice, the minimal operating system necessary to support the function of the container (which in common practice, is a single or monolithic function) is provided.

On top of minimal operating system 942, container 940 may provide one or more services 944. Finally, on top of services 944, container 940 may also provide userspace applications 946, as necessary.

Using containerization layer 916, containerized server 904 may run discrete containers, each one providing the minimal operating system and/or services necessary to provide a particular function. For example, containerized server 904 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

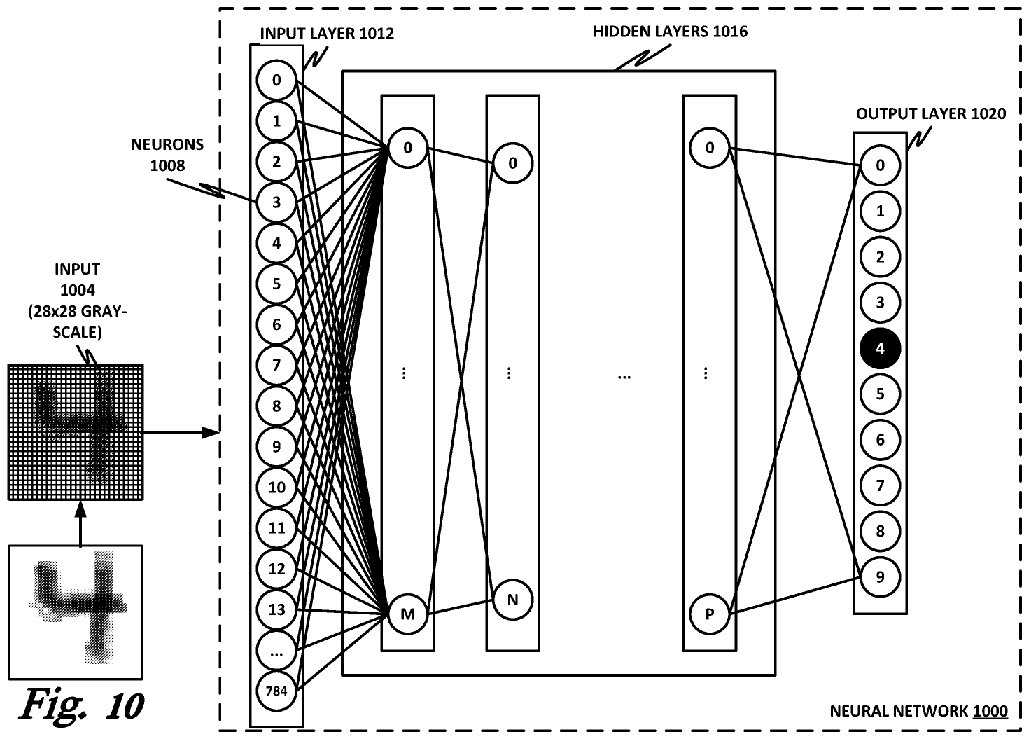

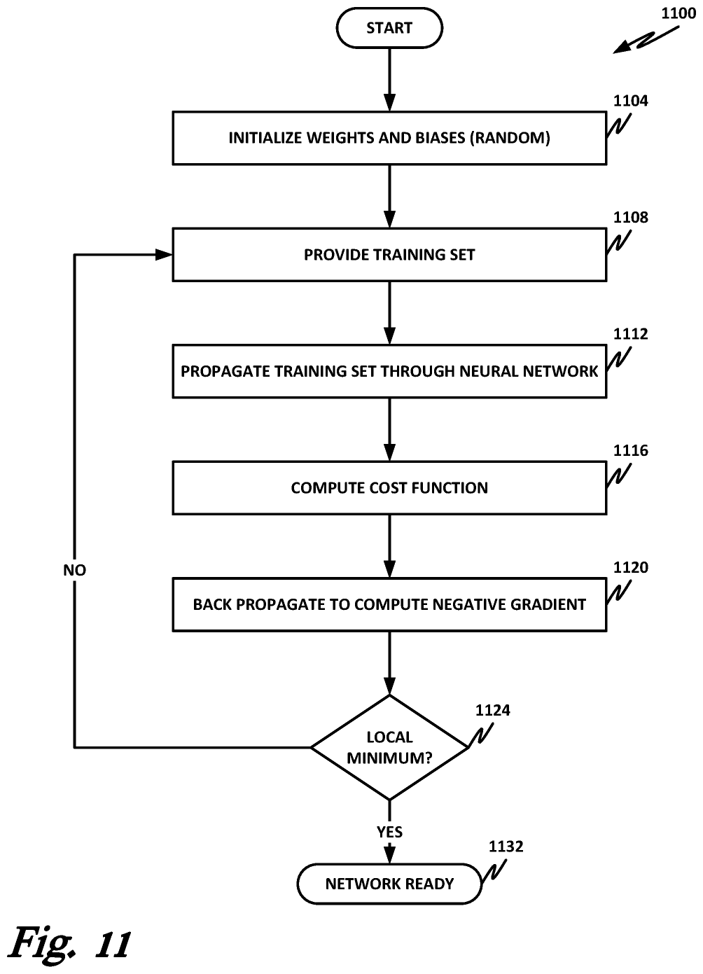

FIGS. 10 and 11 illustrate selected elements of an artificial intelligence system or architecture. In these FIGURES, an elementary neural network is used as a representative embodiment of an artificial intelligence (AI) or machine learning (ML) architecture or engine. These figures represent a nonlimiting example AI. The purpose of these figures is not necessarily to exhaustively reproduce the AI elements of the present specification. The AI principles disclosed in this specification are well-understood in the art, and the IVA and LLM systems disclosed herein are not intended to claim AI itself as a novel technology. Rather, the system and method illustrate a novel application of known AI principles. Thus, the figures provided here are intended to review some foundational concepts of AI (particularly “deep learning” in the context of a deep neural network) and provide a meaningful vocabulary for discussion of AI terms used throughout this specification.

The deep learning network illustrated here should thus be understood to represent AI principles in general. Other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 10 illustrates machine learning according to a “textbook” problem with real-world applications. In this case, a neural network 1000 is tasked with recognizing characters. To simplify the description, neural network 1000 is tasked only with recognizing single digits in the range of 0 through 9. These are provided as an input image 1004. In this example, input image 1004 is a 28×28-pixel 8-bit grayscale image. In other words, input image 1004 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1000 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1000 includes an input layer 1012 and an output layer 1020. In principle, input layer 1012 receives an input such as input image 1004, and at output layer 1020, neural network 1000 “lights up” a perceptron that indicates which character neural network 1000 thinks is represented by input image 1004.

Between input layer 1012 and output layer 1020 are some number of hidden layers 1016. The number of hidden layers 1016 will depend on the problem to be solved, the available compute resources, and other design factors. In general, the more hidden layers 1016, and the more neurons per hidden layer, the more accurate the neural network 1000 may become. However, adding hidden layers and neurons also increases the complexity of the neural network, and its demand on compute resources. Thus, some design skill is required to determine the appropriate number of hidden layers 1016, and how many neurons are to be represented in each hidden layer 1016.

Input layer 1012 includes, in this example, 784 “neurons” 1008. Each neuron of input layer 1012 receives information from a single pixel of input image 1004. Because input image 1004 is a 28×28 grayscale image, it has 784 pixels. Thus, each neuron in input layer 1012 holds 8 bits of information, taken from a pixel of input layer 1004. This 8-bit value is the “activation” value for that neuron.

Each neuron in input layer 1012 has a connection to each neuron in the first hidden layer in the network. In this example, the first hidden layer has neurons labeled 0 through M. Each of the M+1 neurons is connected to all 784 neurons in input layer 1012. Each neuron in hidden layer 1016 includes a kernel or transfer function, which is described in greater detail below. The kernel or transfer function determines how much “weight” to assign each connection from input layer 1012. In other words, a neuron in hidden layer 1016 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1016, until they reach the last layer, which has P+1 neurons labeled 0 through P. Each of these P+1 neurons has a connection to each neuron in output layer 1020. Output layer 1020 includes a number of neurons known as perceptrons that compute an activation value based on their weighted connections to each neuron in the last hidden layer 1016. The final activation value computed at output layer 1020 may be thought of as a “probability” that input image 1004 is the value represented by the perceptron. For example, if neural network 1000 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1016 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + … {w}_{783} {a}_{783}^{( 0 )} + b )$$

In this case, it is assumed that layer 0 (input layer 1012) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + … {w}_{n} {a}_{n}^{( 0 )} + b )$$

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( {Wa}^{( 0 )} + b )$$

Neural connections and activation values are propagated throughout the hidden layers 1016 of the network in this way, until the network reaches output layer 1020. At output layer 1020, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1020 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

### C(w)

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

FIG. 11 is a flowchart of a method 1100. Method 1100 may be used to train a neural network, such as neural network 1000 of FIG. 10.

In block 1104, the network is initialized. Initially, neural network 1000 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1108, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1108, the initial training set is provided to the neural network. Alternatively, the full training set could be used in each iteration.

In block 1112, the training data are propagated through the neural network. Because the initial values are random, and are therefore essentially garbage, it is expected that the output will also be a garbage value. In other words, if neural network 1000 of FIG. 10 has not been trained, when input image 1004 is fed into the neural network, it is not expected with the first training set that output layer 1020 will light up perceptron 4. Rather, the perceptrons may have values that are all over the map, with no clear winner, and with very little relation to the number 4.

In block 1116, a cost function is computed as described above. For example, in neural network 1000, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1120, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1124, the system determines whether it has reached a local minimum (e.g., whether the gradient has reached 0 within the threshold). If the local minimum has not been reached, then the neural network has not been adequately trained, and control returns to block 1108 with a new training set. The training sequence continues until, in block 1124, a local minimum has been reached.

Now that a local minimum has been reached and the corrections have been back-propagated, in block 1132, the neural network is ready.

Although FIGS. 10 and 11 illustrate an AI application for recognizing characters, that function does not represent the limit of modern-day AI practice. AIs have been adapted to many tasks, and generative AIs (GAI) are also common now. For example, generative pre-trained transformer (GPT) networks are popular for their ability to naturally interact with human users, effectively imitating human speech patterns. GAI networks have also been trained for creating and modifying art, engineering designs, books, and other information.

Many of the foregoing GAIs are general-purpose GAIs, meaning that they are trained on very large data sets (e.g., on the order of many terabytes of data), and have general knowledge on many subjects. However, domain-specific AIs are also used in other contexts. General-purpose AIs are generally trained on very large data sets in an unsupervised or semi-unsupervised regimen, which provides the breadth that may benefit a general-purpose AI. Domain-specific AIs are often based on general-purpose AIs, and may start from a pre-trained model. The pre-trained model can then be refined and re-trained using supervised learning, such as with structured, curated, and tagged data sets. This supervised learning can morph the AI model into a model that has specialized utility in a specific knowledge domain.

The foregoing outlines features of several embodiments so that those skilled in the art may better understand various aspects of the present disclosure. The foregoing detailed description sets forth examples of apparatuses, methods, and systems relating to prompt generation for testing, in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-58. (canceled)

59. A computer-implemented method of training an interactive voice assistant (IVA), comprising:
prompting an artificial intelligence (AI) to assume a persona and to seek to fill a service request by a service provider that operates the IVA;
receiving, from the Al, a query for the IVA;
providing the query to the IVA;
receiving, from the IVA, a response to the query;
continuing to permit the Al to query the IVA until the Al is satisfied that the IVA has filled the service request or that the IVA is unable to fill the service request;
logging the queries and responses between the Al and the IVA; and
based on the logging, debugging or improving the IVA.

60. The computer-implemented method of claim 59, wherein the Al is a large language model (LLM).

61. The computer-implemented method of claim 59, wherein the IVA is a less capable machine learning (ML) model than an LLM.

62. The computer-implemented method of claim 59, wherein the IVA comprises a domain-specific LLM.

63. The computer-implemented method of claim 59, further comprising converting the query to speech via a text-to-speech engine before sending the query to the IVA.

64. The computer-implemented method of claim 59, further comprising converting the response to text via a speech-to-text engine before providing the response to the Al.

65. The computer-implemented method of claim 59, wherein the persona comprises being verbose.

66. The computer-implemented method of claim 59, wherein the persona comprises being terse or concise or speaking with poor grammar.

67. The computer-implemented method of claim 59, wherein the persona comprises speaking unusually fast or slow.

68. The computer-implemented method of claim 59, wherein the persona is a person unfamiliar with a service provided by the IVA.

69. The computer-implemented method of claim 59, wherein providing the query to the IVA comprises contacting the IVA via a virtual dialer that simulates a phone interface.

70. The computer-implemented method of claim 59, further comprising causing the Al to generate a large number of service requests to the IVA using a plurality of personas.

71. The computer-implemented method of claim 70, further comprising using automated scripting to cause the Al to generate the large number of service requests.

72. The computer-implemented method of claim 70, further comprising identifying, within the large number of service requests, bad service requests, and dropping the bad service requests.

73. The computer-implemented method of claim 70, wherein debugging comprises identifying service requests that failed, and debugging based on the failed service requests.

74. The computer-implemented method of claim 70, further comprising identifying service requests that succeeded, and preserving at least some successful service requests for regression analysis.

75. One or more tangible, nontransitory computer-readable storage media having stored thereon executable instructions to generate tests for an interactive voice assistant (IVA):
prompt an artificial intelligence (AI) to assume a persona and to seek to fill a service request by a service provider that operates the IVA;
receive, from the Al, a query for the IVA;
provide the query to the IVA;
receive, from the IVA, a response to the query;
continue to permit the Al to query the IVA until the Al is satisfied that the IVA has filled the service request or that the IVA is unable to fill the service request; and
log the queries and responses between the Al and the IVA.

76. The one or more tangible, nontransitory computer-readable storage media of claim 75, wherein the IVA comprises a domain-specific LLM.

77. An orchestrator, comprising:
a hardware platform comprising a processor circuit and a memory;
a user interface;
a first data connection to communicatively couple to a large language model (LLM);
a second data connection to communicatively couple to an interactive voice assistant (IVA); and
instructions encoded within the memory to instruct the processor circuit to:
according to instructions from an operator via the user interface, prompt the LLM to assume a persona and to seek to fill a service request by a service provider that operates the IVA;
receive, via the first data connection, a query for the IVA;
provide the query to the IVA via the second data connection;
receive, via the second data connection, a response to the query;
continue to permit the LLM to query the IVA until the LLM is satisfied that the IVA has filled the service request or that the IVA is unable to fill the service request; and
log the queries and responses between the LLM and the IVA.

78. The orchestrator of claim 77, wherein the IVA comprises a domain-specific LLM.
